(19) United States
(12) Patent Application Publication
(10) Pub. No.: US 2010/0138864 A1
(43) Pub. Date: Jun. 3, 2010

(54) ENHANCED CHANNEL SURFING

(75) Inventor: John H. Yoakum, Cary, NC (US)

Correspondence Address: WITHROW & TERRANOVA, P.L.L.C., 100 REGENCY FOREST DRIVE, SUITE 160, CARY, NC, 27518, US

(73) Assignee: NORTEL NETWORKS LIMITED, St. Laurent (CA)

(21) Appl. No.: 12/326,646

(22) Filed: Dec. 2, 2008

(51) Int. Cl. H04N 5/445

(52) U.S. Cl. 725/44

(57) ABSTRACT

When a viewer initiates channel surfing, a surfing guide is presented to the viewer. The surfing guide provides multiple channel regions, where each channel region is associated with a different channel that is available to the viewer. Each channel region will include a channel window in which an image or video content from the corresponding channel is displayed. When the surfing guide is being displayed to the viewer, the channel window in at least one of the channel regions will include video content, which is derived from a low bandwidth video stream for the associated channel. Each channel region may also have a channel information area in which textual information about the corresponding channel is provided to the viewer.

### FIELD OF THE INVENTION

The present invention relates to channel surfing in a bandwidth constrained environment.

### BACKGROUND OF THE INVENTION

Channel surfing while watching television is commonplace, and any noticeable delays incurred when changing from one channel to the next when channel surfing tend to annoy viewers. With traditional broadcast, cable, and satellite television services, the time it takes a tuner to display another channel in response to a channel change request is very short. Since viewers have grown accustomed to these short channel changes associated with traditional television service, the relatively lengthy delays associated with channel changes in emerging Internet Protocol television (IPTV) environments are problematic. While a single change from one channel to another may not ruin a subscriber's quality of experience, the successive delays incurred while repeatedly changing from one channel to another during a surfing session are deemed unacceptable.

In bandwidth constrained environments like an IPTV environment, each time a new channel is selected for viewing, the set-top box or other customer premise equipment must first request the channel from a video server of the service provider. The video server or associated service node must process the request, access the video stream for the requested channel, and then start delivering the video stream to the set-top box. As such, the set-top box must wait for the video server to start delivering the video stream before being able to display video content from the video stream to the subscriber. These delays are not insubstantial, especially for higher bandwidth video streams that are used for both standard and high definition television content.

When channel surfing is occurring, this process of requesting video content for the next channel and waiting a significant amount of time for the corresponding video stream to be received occurs for each channel that is surfed. As such, channel surfing is meet with successive and extensive delays that are annoying, if not unacceptable, by subscribers. As such, there is a need for an enhanced channel surfing technique that is pleasing to subscribers and relatively bandwidth efficient for service and network providers.

### SUMMARY OF THE INVENTION

The present invention provides a mechanism to allow efficient and effective channel surfing in IPTV and like environments. When a viewer initiates channel surfing, a surfing guide is presented to the viewer. The surfing guide provides multiple channel regions, where each channel region is associated with a different channel that is available to the viewer. Each channel region will include a channel window in which an image or video content from the corresponding channel is displayed. When the surfing guide is being displayed to the viewer, the channel window in at least one of the channel regions will include video content, which is derived from a low bandwidth video stream for the associated channel. Each channel region may also have a channel information area in which textual information about the corresponding channel is provided to the viewer.

As the viewer scrolls through the surfing guide, the channel regions are updated accordingly. At any given time, one of the channel regions may be deemed active and highlighted in some fashion. Selection of the active channel in the active channel region by the viewer may result in removing the surfing guide from display to the viewer and presenting to the viewer video content for the active channel. This video content presented to the viewer is derived from a high bandwidth video stream and corresponds to the video content that was provided in the channel window of the active channel region in the surfing guide.

In one embodiment of the present invention, the channel window for some or all of the channel regions in the surfing guide provide video content, which is derived from a low bandwidth video stream for the corresponding channel. In another embodiment, at least the channel window in the highlighted channel region of the surfing guide provides video content, which is derived from a low bandwidth video stream for the corresponding channel. The other non-highlighted channel regions in the surfing guide may provide static images associated with the corresponding channels, instead of video content. In certain embodiments, one or more high bandwidth video streams may be available for certain channels that appear in the surfing guide. When a channel region of the surfing guide is associated with a channel for which high bandwidth video streams are available, the video content that is provided in the channel window for the associated channel may be derived either from the corresponding high bandwidth video stream or from a separate low bandwidth video stream.

The low bandwidth video streams that are needed to provide video content for content windows of the surfing guide may be provided prior to being needed for the surfing guide or may be dynamically fetched on an as needed basis. For example, low bandwidth video streams may be provided for most, if not all, of the available channels all of the time. As video content is needed for the channel windows in the surfing guide, the corresponding low bandwidth video streams are processed and used for providing the video content in the channel windows. To reduce the number of low bandwidth video streams necessary to support the surfing guide at any time, the channels that the viewer are likely to surf may be predicted and low bandwidth video streams for the predicted channels are fetched in advance of being needed for surfing guide. The prediction of channels likely to be surfed may be based on various criteria, including how the surfing guide was activated, the channel being viewed when the surfing guide was activated, surfing habits of viewers in general, past or current surfing habits of the viewer, the nature or direction of the surfing, program content, and the like.

Those skilled in the art will appreciate the scope of the present invention and realize additional aspects thereof after reading the following detailed description of the preferred embodiments in association with the accompanying drawing figures.

### BRIEF DESCRIPTION OF THE DRAWING FIGURES

The accompanying drawing figures incorporated in and forming a part of this specification illustrate several aspects of the invention, and together with the description serve to explain the principles of the invention.

FIG. 1 is an IPTV environment according to one embodiment of the present invention.

FIG. 2 illustrates a program being displayed on a monitor.

FIGS. 3A, 3B, and 3C illustrate initial display of and channel surfing via a surfing guide according to one embodiment of the present invention.

FIGS. 4A and 4B illustrate initial display of and channel surfing via a surfing guide according to another embodiment of the present invention.

FIG. 5 illustrates an expanded channel information window according to one embodiment to one embodiment of the present invention.

FIG. 6 is a block representation of customer premise equipment according to one embodiment of the present invention.

FIG. 7 is a block representation of a server according to one embodiment of the present invention.

### DETAILED DESCRIPTION OF THE PREFERRED EMBODIMENTS

The embodiments set forth below represent the necessary information to enable those skilled in the art to practice the invention and illustrate the best mode of practicing the invention. Upon reading the following description in light of the accompanying drawing figures, those skilled in the art will understand the concepts of the invention and will recognize applications of these concepts not particularly addressed herein. It should be understood that these concepts and applications fall within the scope of the disclosure and the accompanying claims.

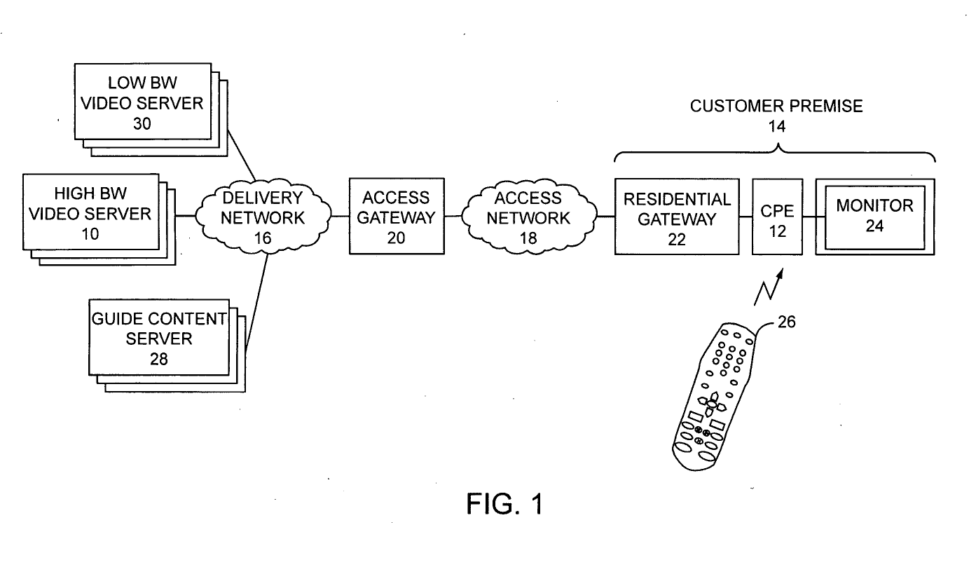

For the following description, low and high bandwidth video streams may be employed to provide the same general video content for a given channel at any given time. A high bandwidth video stream will require substantially more bandwidth to deliver the video content to a subscriber from a service provider than the corresponding low bandwidth video stream. The high bandwidth video stream is generally used for normal viewing while the low bandwidth video stream is generally used to fill a relatively small window in a surfing guide configured according to the present invention. Typically the low bandwidth video stream is more highly compressed and may have a lower resolution than the corresponding high bandwidth video stream. The required bandwidth for a low bandwidth video stream is often one-half and perhaps one-tenth or less than that of the high bandwidth video stream. Prior to delving into the details of the present invention, an overview of an Internet Protocol Television (IPTV) environment is provided according to one embodiment of the present invention in association with FIG. 1. After understanding the concepts of the present invention, those skilled in the art will recognize other IPTV or like media environments in which the concepts of the present invention may be employed.

As depicted, streaming media is selectively delivered from one or more high bandwidth video servers 10 to customer premise equipment (CPE) 12 at a customer premise 14 over a delivery network 16. The delivery network 16 may be connected to the CPE 12 through an access network 18, which may be coupled to the delivery network 16 via an access gateway 20 and may be coupled to a residential gateway 22 at the customer premises 14. The access gateway 20 provides any necessary interworking between the delivery network 16 and the access network 18, while the residential gateway 22 provides any necessary interworking between the access network 18 and the CPE 12. The delivery network 16 may represent a backbone or transport portion of a cable, telephony, satellite network, or a combination thereof that is capable of delivering content from the high bandwidth video servers 10 to the appropriate access networks 18, which serve the customer premises 14 of the subscribers.

The CPE 12 may represent a set-top box (STB), digital video recorder, media server or computer, cable card, television or the like that is capable of receiving the media streams from the high bandwidth television servers and effecting display of the content provided in the media streams to a viewer through an associated monitor 24. The CPE 12 may be controlled by an associated user interface or via a remote control 26. In the illustrated IPTV environment, assume that one or more service providers employs the high bandwidth video servers 10 to deliver high bandwidth video streams for television or other content to the CPE 12. Further assume that the different high bandwidth video streams carry different program content and correspond to different television channels that are available to the subscribers.

Assuming that it is undesirable or there is insufficient bandwidth to deliver high bandwidth video streams for all channels to the CPEs 12 of all subscribers at any given time, only one high bandwidth video stream or a subset of a larger group of high bandwidth video streams for a corresponding channel or subset of channels are actually provided to the CPE 12 of a given subscriber at any given time. As such, when a viewer selects a channel for viewing for which a high bandwidth video stream is not currently being received by the CPE 12, the CPE 12 will request the corresponding high bandwidth video stream for the channel and, when the high bandwidth video stream becomes available, effect display of the content of the high bandwidth video stream to the viewer via the monitor 24.

The high bandwidth video streams for the different channels generally originate from the high bandwidth video servers 10; however, requests from a CPE 12 for the high bandwidth video streams for specific channels may be processed by different network entities. In a first configuration, the high bandwidth video servers 10 provide high bandwidth video streams for many or all of the channels to the access gateway 20 all of the time; however, only the requested high bandwidth video streams are provided to the CPE 12 over the access network 18 at any given time. In operation, the CPE 12 will request high bandwidth video streams for desired channels from the access gateway 20, which will initiate delivery of the requested high bandwidth video streams over the access network 18 to the CPE 12. In this first configuration, the delivery network 16 has sufficient bandwidth to deliver a large number of the high bandwidth video streams while bandwidth is conserved in the access network 18. Those skilled in the art will recognize that other service nodes may be used as intermediaries, which receive a large number of high bandwidth video streams from the high bandwidth video servers 10 and selectively deliver requested high bandwidth video streams to the CPE 12.

In a second configuration, at least some of the high bandwidth video streams are requested from the high bandwidth video servers 10 or a control server (not illustrated) that is associated therewith. In operation, the CPE 12 may request high bandwidth video streams for desired channels from the high bandwidth video servers 10, which will initiate delivery of the requested high bandwidth video streams over the delivery network 16 and the access network 18 to the CPE 12. Accordingly, the high bandwidth video streams for different channels may be dynamically requested as needed from different service nodes at different locations in an IPTV environment, in the different network configuration. Regardless of the network configuration, the CPE 12 from time to time will have to request a high bandwidth video stream from a service node in the network, wait for the high bandwidth video stream to be received, and then process the high bandwidth video stream to effect delivery of the content provided in the high bandwidth video stream to the monitor 24 for viewing.

Unfortunately, requesting a high bandwidth video stream for a given channel, allowing the service node to initiate delivery of the high bandwidth video stream, beginning to receive the high bandwidth video stream, and processing the high bandwidth video stream to effect delivery of the content provided in the high bandwidth video stream to the monitor 24 for viewing often takes longer than an insubstantial amount of time. When a viewer is channel surfing, and thus rapidly changing from one channel to another, the delay associated with retrieving a high bandwidth video stream for each channel change during surfing is generally substantially longer than what subscribers have grown accustomed to with traditional broadcast, cable, and satellite televisions services. These delays tend to be annoying and significantly detract from the subscriber's overall satisfaction with IPTV services. The present invention provides a technique to significantly improve a subscriber's surfing experience in an IPTV environment without substantially increasing the amount of bandwidth necessary for providing IPTV services.

Traditional channel surfing generally involves a subscriber rapidly changing from one channel to another. With each subscriber command, the CPE 12 will access a new channel and effect delivery of the content for the channel to the monitor 24 for viewing. In essence, traditional channel surfing is merely a rapid sequence of channel changes. With the present invention, initiation of channel surfing will entail activating a special surfing guide and continued channel surfing will entail scrolling through the surfing guide in a desired fashion. As will be described below, the surfing guide may include channel windows in which static images or video content for corresponding channels are presented to the user in association with channel information for the corresponding channels. Preferably, certain or all of the video content that is provided for the channel windows is derived from low bandwidth video streams, which are separate from the high bandwidth video streams used to deliver the video content that is delivered to the subscriber under normal viewing conditions when the surfing guide is not activated. The surfing guide may also contain advertising content in any format, including text, graphics, images, video, and audio. The advertising content may be generically selected or may be based on program content or the specific subscriber. Further, the advertising content may be provided in high or low bandwidth media streams from the high or low bandwidth servers 10, 30.

As illustrated in FIG. 1, one or more guide content servers 28 are used to provide the channel information that is used to populate the surfing guide. The guide servers 28 are configured to directly or indirectly deliver the channel information to the CPE 12 on an as needed or periodic basis. One or more low bandwidth video servers 30 are used to provide the low bandwidth video streams to the CPE 12 or an appropriate service node, such as the access gateway 20. Notably, corresponding low bandwidth video streams and the high bandwidth video streams carry the same content. A given channel may have a high bandwidth video stream and a low bandwidth video stream, which is preferably synchronized to a reasonable degree with the high bandwidth video stream.

The low bandwidth video stream for a given channel is preferably a lower resolution or more highly compressed version of the high bandwidth video stream, and thus, requires substantially less bandwidth than the high bandwidth video stream to be delivered to the CPE 12. Although the high and low bandwidth video servers 10, 30 are shown as separate servers for clarity, a single media server may provide both the high and low bandwidth video streams for a given channel. Further, the high and low bandwidth video streams may include associated audio content in addition to any video content for a given program.

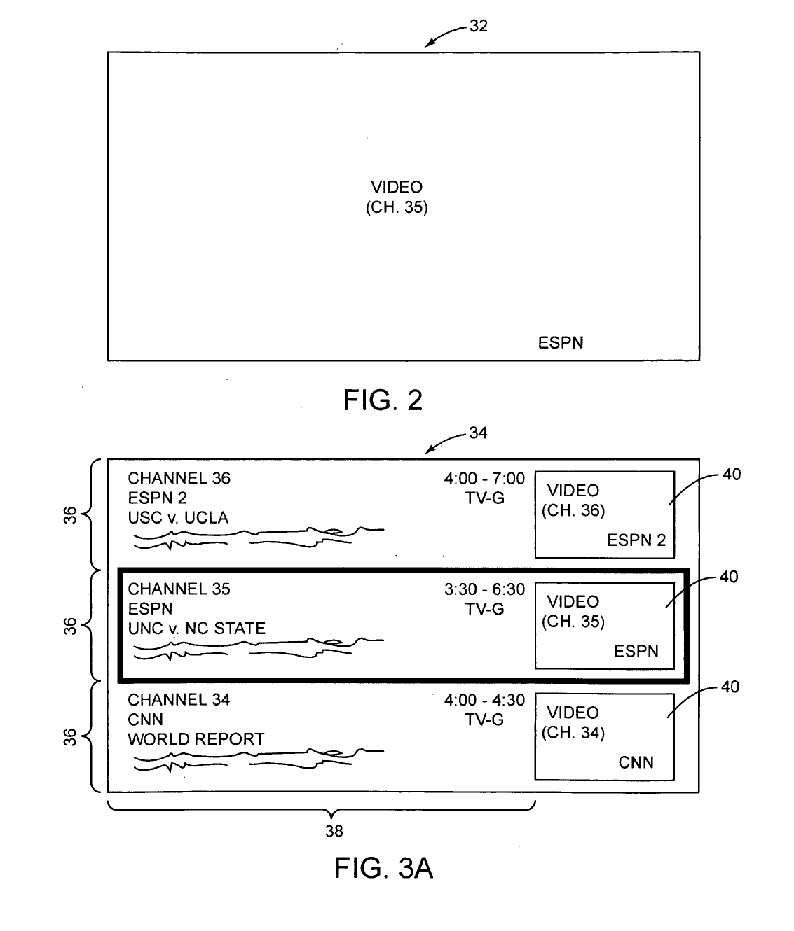

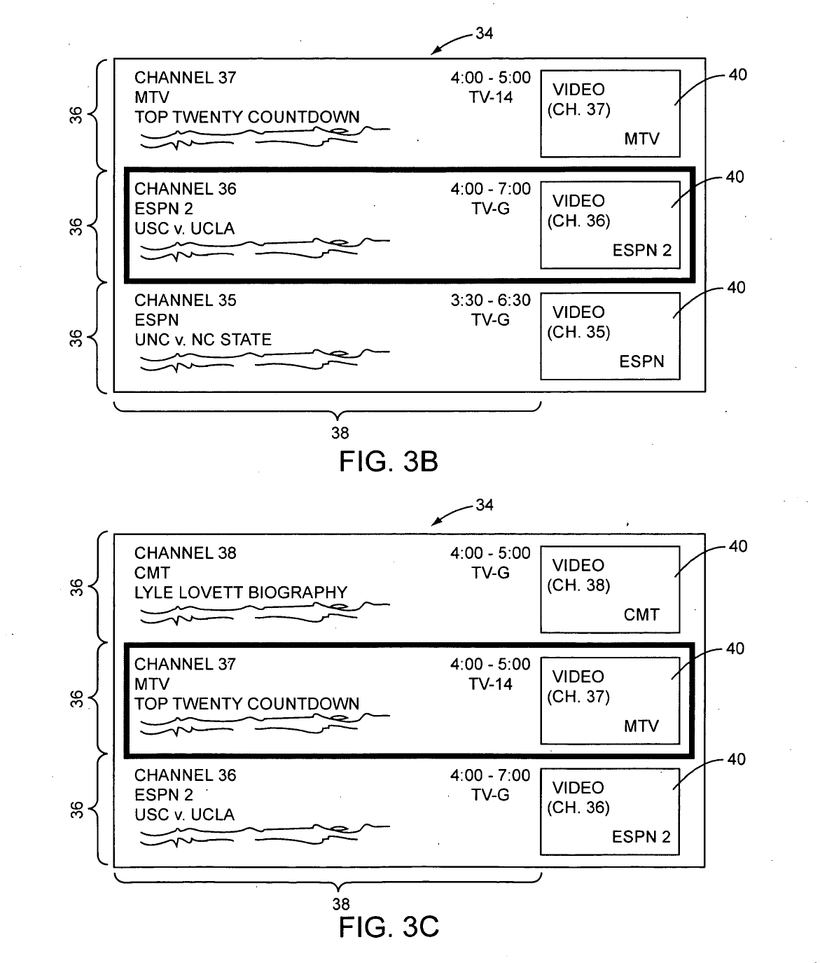

With reference to FIG. 2, assume a subscriber is viewing a program 32 on an initial channel. As depicted, the initial channel is channel 35 (CH. 35), which corresponds to ESPN. Upon initiating a surfing action, such as pressing a channel up or down button, surfing guide button, or entering a channel to be viewed on the remote control 26, assume the CPE 12 generates and effects display of a surfing guide 34, which is configured according to one embodiment of the present invention, on the monitor 24 as illustrated in FIG. 3A. The surfing guide 34 preferably provides one or more channel regions 36, each of which is associated with a different channel that is available to the subscriber. Each channel region 36 may have a channel information area 38 in which textual information about the corresponding channel is provided to the viewer. The textual information represents guide information that may be provided by the guide content server 28.

Each channel region 36 may include a channel window 40 in which video content from the corresponding channel is displayed. When the surfing guide 34 is being displayed to the subscriber, the channel window 40 in each of the channel regions 36 will include video content, which is derived from a low bandwidth video stream for the associated channel. The low bandwidth video stream may be provided by the low bandwidth video server 30 or by the high bandwidth video server 10 in other embodiments. Assume the surfing guide 34 illustrated in FIG. 3A is an initial surfing guide 34 that is provided in response to the subscriber activating the surfing guide 34 while viewing program content from ESPN on initial channel 35 (CH. 35). In this embodiment, the surfing guide 34 includes three channel regions 36, wherein the central channel region 36 is allocated to the initial channel 35 (CH. 35). The upper channel region 36 is allocated to channel 36 (CH. 36) and the lower channel region 36 is allocated to channel 34 (CH. 34).

As depicted, the initial channel 35 (CH. 35) corresponds to program content from ESPN, and in particular to a football game between the University of North Carolina (UNC) and North Carolina State University (NC State). The channel information area 38 for the central channel region 36 may include guide information identifying the program (UNC v. NC State), the associated television rating (TV-G), the scheduled air time (3:30-6:30), and any other information deemed pertinent for the viewer. Notably, the channel window 40 includes video content, which may be provided from a low bandwidth video stream or derived from the high bandwidth video stream that was being used for the initial channel 35 prior to activating the surfing guide 34. The video content is that of the program (UNC v. NC State).

The upper channel region 36 is allocated to channel 36 (CH. 36) and corresponds to program content from ESPN 2, and in particular to a football game between the University of Southern California (USC) and the University of California—Los Angeles (UCLA). The channel information area 38 for the upper channel region 36 may include guide information identifying the program (USC v. UCLA), the associated television rating (TV-G), the scheduled air time (4:00-7:00), and any other information deemed pertinent for the viewer. Notably, the channel window 40 for the upper channel region 36 includes video content for the program (USC v. UCLA) that is provided from a low bandwidth video stream.

The lower channel region 36 is allocated to channel 34 (CH. 34) and corresponds to program content from CNN, and in particular to a program entitled “World Report.” The channel information area 38 for the lower channel region 36 may include guide information identifying the program (World Report), the associated television rating (TV-G), the scheduled air time (4:00-4:30) and any other information deemed pertinent for the viewer. The channel window 40 for the lower channel region 36 includes video content for the program (World Report) that is provided from a low bandwidth video stream. At this point assume the central channel region 36 is highlighted in some fashion, such as providing a dark border about the perimeter of the central channel region 36 as depicted. The highlighting identifies active channel region 36, which if selected, will result in the surfing guide 34 being removed and the active channel allocated to the active channel region 36 being displayed to the subscriber in normal fashion from a high bandwidth video stream. In this example, assume that the audio associated with the active channel is provided while the surfing guide 34 is active, and that the audio is derived from the same video stream from which the video content being provided in the channel window 40 is supplied.

The low bandwidth video streams that are used for the channel windows 40 in the surfing guide 34 preferably provide the same video content that would be provided by the corresponding high bandwidth video streams, and as such, the video content in corresponding low and high bandwidth video streams are preferably substantially synchronized. As such, the subscriber is able to view the current video content for the channels provided in the surfing guide 34; however, the CPE 12 does not have to be receiving the high bandwidth video streams for any or all of these channels. The CPE 12 only needs to be receiving the low bandwidth video streams for these channels to populate the corresponding channel windows 40 of the surfing guide 34.

As indicated, a channel region 36 in the surfing guide 34 may be initially populated with the initial channel (CH. 35) that was being watched when the guide was activated. In such instances, the high bandwidth video stream for the initial channel (CH. 35) is already being received, and as such, can be used to populate the channel window 40 for the initial channel (CH. 35). Accessing the low bandwidth video stream for the initial channel (CH. 35) can be avoided. Alternatively, the low bandwidth video stream for the initial channel (CH. 35) may be accessed along with the low bandwidth video streams for the channel 34 (CH. 34) and channel 36 (CH. 36) and used to populate the channel window 40 for the initial channel (CH. 35).

Surfing through the surfing guide 34 may entail stepping or scrolling from one channel region to another within the surfing guide 34 in response to subscriber input. Assume the subscriber was initially presented the surfing guide 34 depicted in the FIG. 3A and subsequently presses the channel up or similar button on the remote control 26 to move up one channel such that channel 36 (CH. 36) becomes the highlighted or active channel. As a result, the surfing guide 34 may be updated as illustrated in FIG. 3B, wherein the lower channel region 36 is reallocated to the initial channel 35 (CH. 35), the central channel region 36 is reallocated to channel 36 (CH. 36), and the upper channel region 36 is reallocated to channel 37 (CH. 37). Notably, channel 34 (CH. 34) is no longer represented in the surfing guide 34 and channel 37 (CH. 37) has appeared in the surfing guide 34 for the first time in the upper channel region 36.

As depicted, channel 37 (CH. 37) corresponds to program content from MTV, and in particular to a program entitled “Top Twenty Countdown.” The channel information area 38 for the upper channel region 36 may include guide information identifying the program (Top Twenty Countdown), the associated television rating (TV-14), the scheduled air time (4:00-5:00), and any other information deemed pertinent for the viewer. Notably, the channel window 40 for the upper channel region 36 includes video content for the program (Top Twenty Countdown) that is provided from a low bandwidth video stream.

Next, assume the subscriber once again presses the channel up or similar button on the remote control 26 to move up one more channel such that channel 37 (CH. 37) becomes the highlighted or active channel. As a result, the surfing guide 34 may be updated once again as illustrated in FIG. 3C, wherein the lower channel region 36 is reallocated to the channel 36 (CH. 36), the central channel region 36 is reallocated to channel 37 (CH. 37), and the upper channel region 36 is reallocated to channel 38 (CH. 38). Notably, initial channel 35 (CH. 35) is no longer represented in the surfing guide 34 and channel 38 (CH. 38) has appeared in the surfing guide 34 for the first time in the upper channel region 36.

As depicted, channel 38 (CH. 38) corresponds to program content from CMT, and in particular to a program entitled “Lyle Lovett Biography.” The channel information area 38 for the upper channel region 36 may include guide information identifying the program (Lyle Lovett Biography), the associated television rating (TV-G), the scheduled air time (4:00-5:00), and any other information deemed pertinent for the viewer. Notably, the channel window 40 for the upper channel region 36 includes video content for the program (Lyle Lovett Biography) that is provided from a low bandwidth video stream. At this point, even if the video content for channel windows 40 associated with initial channel 35 (CH. 35) was derived from a high bandwidth video stream, all of the video content used in each of the channel windows 40 may now be provided from low bandwidth video streams, because the surfing guide 34 no longer includes a channel region 36 allocated to the initial channel 35 (CH. 35).

As the subscriber steps or scrolls up or down through the surfing guide 34 by one or more channels at a time, the channel regions 36 are updated accordingly. At any given time, one of the channel regions 36 is deemed active and highlighted in some fashion. Selection of the active channel in the active channel region 36 by the subscriber may result in removing the surfing guide 34 from display to the subscriber and presenting to the subscriber with video content for the active channel, which is derived from a high bandwidth video stream and corresponds to the video content that was provided in the channel window 40 of the active channel region 36.

In the above example, each of the channel windows 40 will provide video content for the corresponding channels. In other embodiments, certain channel windows 40 may provide video content while other channel windows 40 in the same surfing guide 34 provide static information, such as images, text, or graphics, which bear on the corresponding channels or video content of the corresponding channels. In the following example, the channel windows 40 of the upper and lower channel regions 36 of the surfing guide 34 provide static images that bear on the corresponding channels, while the channel window 40 of the central channel region 36 provides video content that is derived from a low bandwidth video stream for the corresponding channel.

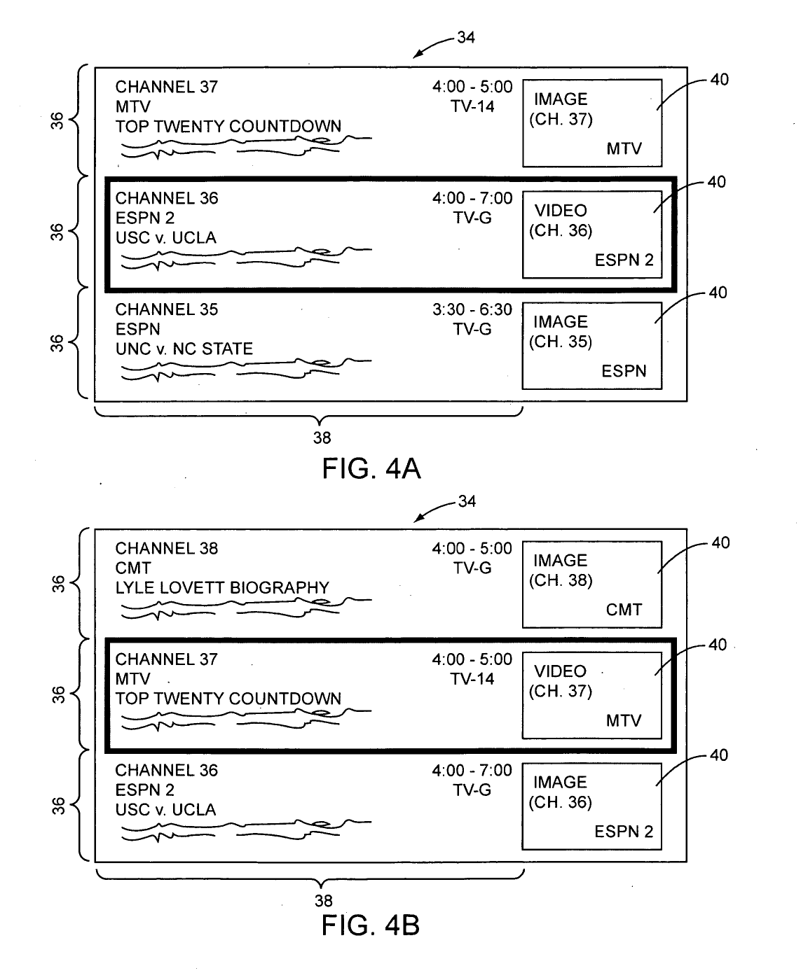

Assume the surfing guide 34 illustrated in FIG. 4A is an initial surfing guide 34 that is provided in response to the subscriber activating the surfing guide 34 while viewing program content from ESPN 2 on initial channel 36 (CH. 36). Assume that the surfing guide 34 includes three channel regions 36, wherein the central channel region 36 is allocated to the initial channel 36 (CH. 36). The upper channel region 36 is allocated to channel 37 (CH. 37) and the lower channel region 36 is allocated to channel 35 (CH. 35). As depicted, the central channel region 36 is designated the active channel region and is highlighted accordingly. Those skilled in the art will recognize that any channel region 36 may be designated an active channel region associated with an active channel.

As depicted, channel 37 (CH. 37) corresponds to program content from MTV, and in particular to the program entitled “Top Twenty Countdown.” The channel information area 38 for the upper channel region 38 may include guide information identifying the program (Top Twenty Countdown), the associated television rating (TV-14), the scheduled air time (4:00-5:00), and any other information deemed pertinent for the viewer. Notably, the channel window 40 for the upper channel region 36 includes a static image or the like for the program (Top Twenty Countdown) or channel 37 (CH. 37) in general, and may be obtained with the guide information for the program from the guide content server 28 or other source. The static image or the like need not be provided with a high or low bandwidth video stream associated with channel 37 (CH. 37).

Channel 35 (CH. 35) corresponds to program content from ESPN, and in particular to the football game between UNC and NC State. The channel information area 38 for the lower channel region 36 may include guide information identifying the program (UNC v. NC State), the associated television rating (TV-G), the scheduled air time (3:30-6:30), and any other information deemed pertinent for the viewer. Like the upper channel region 36, the channel window 40 for the lower channel region 36 includes a static image or the like for the program (UNC v. NC State) or channel 35 (CH. 35) in general. The static image or the like may, but need not be, provided with a high or low bandwidth video stream associated with channel 35 (CH. 35) or from the high or low bandwidth video server 10 and 30. The static images may also be provided from the guide content server 28 or other appropriate source. The static images may be obtained in advance of or as needed in response to surfing being initiated.

The central channel region 36 is allocated to channel 36 (CH. 36) and corresponds to program content from ESPN 2, and in particular to the football game between the USC and UCLA. The channel information area 38 for the central channel region 36 may include guide information identifying the program (USC v. UCLA), the associated television rating (TV-G), the scheduled air time (4:00-7:00) and any other information deemed pertinent for the viewer. Unlike the upper and lower channel regions 36, the channel window 40 for the central channel region 36 includes video content for the program (USC v. UCLA) instead of a static image or the like. The video content for the channel window 40 of the central channel region 36 is provided by a low bandwidth video stream for channel 36 (CH. 36).

Next, assume the subscriber presses the channel up or similar button on the remote control 26 to move up one more channel such that channel 37 (CH. 37) becomes the highlighted or active channel. As a result, the surfing guide 34 may be updated as illustrated in FIG. 4B wherein the lower channel region 36 is reallocated to the channel 36 (CH. 36), the central channel region 36 is reallocated to channel 37 (CH. 37), and the upper channel region 36 is reallocated to channel 38 (CH. 38). Notably, channel 35 (CH. 35) is no longer represented in the surfing guide 34 and channel 38 (CH. 38) has appeared in the surfing guide 34 for the first time in the upper channel region 36.

As above, channel 38 (CH. 38) corresponds to program content from CMT, and in particular to the program entitled “Lyle Lovett Biography.” The guide information area 38 for the upper channel region 36 may include guide information identifying the program (Lyle Lovett Biography), the associated television rating (TV-G), the scheduled air time (4:00-5:00), and any other information deemed pertinent for the viewer. Notably, the channel window 40 for the upper channel region 36 includes a static image or the like for the program (Lyle Lovett Biography) or channel 38 (CH. 38) in general and may be obtained with the guide information for the program from the guide content server 28 or other source. The static image or the like need not be provided with a high or low bandwidth video stream associated with channel 38 (CH. 38).

The central channel region 36 is now allocated to channel 37 (CH. 37) and corresponds to program content from MTV, and in particular to the program “Top Twenty Countdown.” The channel information area 38 for the central channel region 36 may include guide information identifying the program (Top Twenty Countdown), the associated television rating (TV-14), the scheduled air time (4:00-5:00), and any other information deemed pertinent for the viewer. Unlike the upper and lower channel regions 36, the channel window 40 for the central channel region 36 includes video content for the program (Top Twenty Countdown) instead of a static image or the like. The video content for the channel window 40 of the central channel region 36 is provided by a low bandwidth video stream for channel 37 (CH. 37). Notably, once a low bandwidth stream is being received, it may continue to be used for the surfing guide 34.

Although the above examples illustrate the surfing guide 34 to include channels in sequential and numerical order, the channels to be surfed and thus provided in the surfing guide 34 may be arranged in any order and selected based on any criteria. For example, the channels to be surfed may be selected based on type, rating, or the like. The channels to be surfed may also be defined by the subscriber or selected by the service provider. For example, the favorite channels of a subscriber may be identified and the surfing guide 34 will allow the subscriber to surf through previously identified favorites. Further, the layout and arrangement of the channel regions 36, the channel information areas 38, and the channel windows 40 may vary as desired by the service provider or subscriber. Any number of channel regions 36 may be provided in the surfing guide 34 at any given time. Further, the surfing guide 34 may be provided within or in place of the initial program being displayed when the surfing guide 34 is initiated. Such design considerations are within the purview of the designer of the surfing guide 34. If advertising content is provided, the advertising content may be provided in or in association with the channel regions 36 or channel information area 38. As noted above, the advertising content may be provided in high or low bandwidth streams.

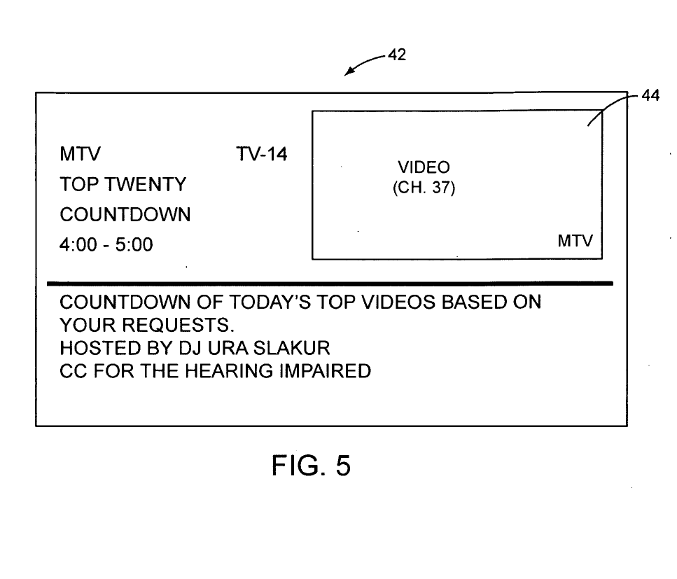

While the surfing guide 34 is being displayed, additional information for a given channel in a selected channel region 36 may be presented to the subscriber in an extended information window 42 upon receiving certain input from the subscriber. An exemplary extended information window 42 is illustrated in FIG. 5 and may include a channel window 44 and additional channel information than what was provided in the channel region 36. The video content in the channel window 44 may be provided by a low bandwidth video stream for the corresponding channel.

The low bandwidth video streams that are needed to provide video content in channel windows 40 of the surfing guide 34 may be provided in different ways. Perhaps the simplest but least efficient way is to continuously provide the low bandwidth video streams for all or substantially all of the available channels. As such, the low bandwidth video streams that are needed for the surfing guide 34 are readily available whenever they are needed. To reduce bandwidth needed to provide the low bandwidth video streams, the channels to be surfed, and thus likely to appear in the surfing guide 34, may be predicted using various techniques and criteria. The channel prediction may be based on how the surfing guide 34 was activated, the current channel being viewed by the subscriber, prior surfing characteristics of the subscriber, current surfing characteristics of the subscriber, typical surfing characteristics of subscribers in general, and the like as well as any combination thereof. Surfing characteristics may relate to the nature or direction of surfing, program content of channels surfed, and the like.

For example, when an initial channel is being viewed, low bandwidth video streams for at least one channel above and below the initial channel and perhaps the initial channel are fetched prior to the surfing guide 34 being activated. As the subscriber changes channels, the low bandwidth video streams for the channels adjacent the initial channel being viewed are fetched. As such, the low bandwidth video streams for the channels above and below the initial channel being viewed and perhaps the initial channel itself are received, while the high bandwidth video stream for the initial channel is being received and used for delivering video content for the initial channel to the viewer prior to the surfing guide 34 being activated. When activated by the subscriber, the surfing guide 34 is presented to the viewer and may include channel regions 36 for the channels above and the below the initial channel and perhaps the initial channel itself. The channel windows 40 of the channel regions 36 for the channels above and below the initial channel are filled with video content derived from the low bandwidth video streams that were available prior to activation of the surfing guide 34. The channel window 40 for the initial channel may be derived from a low bandwidth video stream for the initial channel or the high bandwidth video stream for the initial channel.

Once the surfing guide 34 is initially activated, low bandwidth video streams for additional channels that are not currently represented in the surfing guide 34 may be fetched in anticipation of the subscriber surfing through the surfing guide 34. The additional channels may be predicted based on the channels currently represented in the surfing guide 34, the button used to activate the surfing guide 34, surfing habits of the subscriber or other subscribers, and the like. For example, if the subscriber pressed the channel up button on the remote control 26, there is a strong indication that the subscriber will surf upwards through the surfing guide 34. While the initial surfing guide 34 is being generated and displayed as described above, low bandwidth video streams for the higher channels that will next appear in the surfing guide 34 if the subscriber surfs upward through the guide are fetched. When the subscriber presses the channel up button again once the surfing guide 34 is displayed, the surfing guide 34 will be updated and may use one or more of the low bandwidth video streams for the higher channels. This process will repeat as surfing continues. Further, low bandwidth video streams for channels deemed no longer necessary for the surfing may be dropped, and if necessary, subsequently resumed.

With the above example, channels to be surfed were predicted based on the numerical order and the direction of surfing; however, any criteria may be used to predict channels to be surfed. If the subscriber is surfing through their favorite channels by repeatedly pressing a favorites button on the remote control 26, the surfing guide 34 will be populated with certain favorite channels at any given time, while the low bandwidth video streams for those favorite channels that are likely to appear next in the surfing guide 34 during the surfing session are fetched in advance of further subscriber input. As such, the low bandwidth video streams may be fetched in preparation for a surfing event that never occurs, and as such, video content from a low bandwidth video stream that was fetched is not used in the surfing guide 34. If the subscriber is surfing through certain channels in a recognizable order, the surfing guide 34 will be populated with certain of these channels at any given time, while the low bandwidth video streams for those channels that appear further up or down in the order are fetched in advance of further subscriber input.

Alternatively, low bandwidth video streams may be fetched dynamically, wherein the low bandwidth video streams for channels appearing in the surfing guide 34 are fetched only when needed. For example, when an initial channel is being viewed and the surfing guide 34 is activated based on the subscriber pressing a channel up button, low bandwidth video streams for the three channels above the initial channel are immediately fetched. Notably, in this example, the initial channel is not provided in the initial surfing guide 34 and only the next three channels above the initial channel are provided in the initial surfing guide 34. Once the dynamically fetched low bandwidth video streams become available, the video content from each of the respective low bandwidth video streams is used to populate the channel windows 40 of the channel regions 36. The active or highlighted channel may be the channel most proximate to the initial channel for the initial surfing guide 34 and may change from one channel to another based on surfing. Each time the surfing guide 34 requires updating in response to surfing by the subscriber, the low bandwidth video streams for channels appearing in the surfing guide 34 are fetched in a dynamic fashion. Notably, the surfing guide 34 need not be updated for each surfing event, such that the active or highlighted channel (or associated channel region 36) may change within a given instance of the surfing guide 34.

Notably, channel prediction and dynamic fetching may be employed together such that the low bandwidth video streams for channels that could not be predicted, and thus be fetched in advance of being needed, are dynamically fetched when needed. As a further example, prediction may be used for the initial surfing guide 34 while dynamic fetching is used for updating the surfing guide 34 during subsequent surfing, and vice versa. Virtually any combination is possible.

The high and low bandwidth video streams as well as any guide information, which may include textual information, static images, and the like, may be requested by the CPE 12 or pushed to the CPE 12 by the corresponding high bandwidth video server 10, low bandwidth video server 30, guide content server 28, or the like. Any one of these servers or other servers may also keep track of user profiles, individual surfing characteristics, general surfing characteristics, and the like to aid in predicting channels to be surfed or other surfing operation and control.

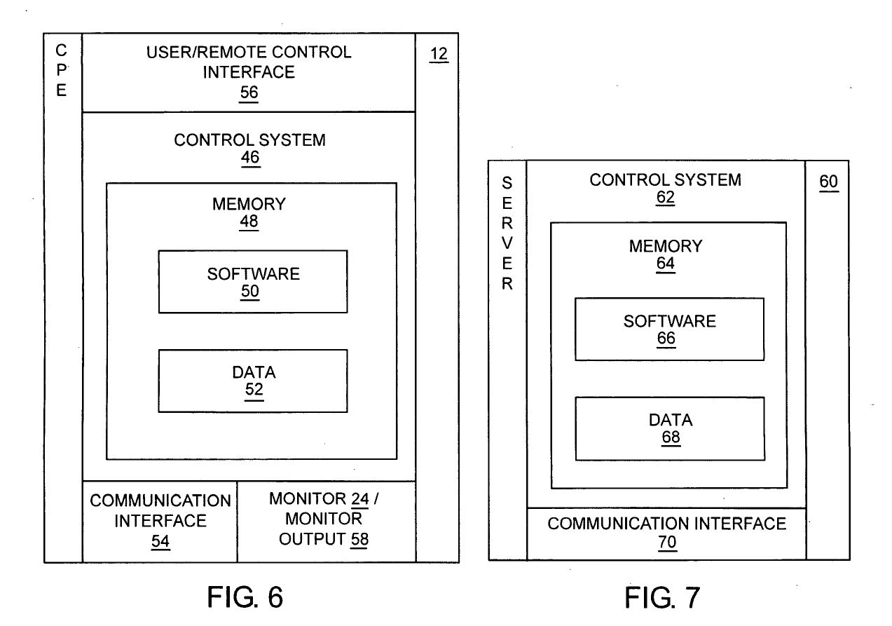

Turning now to FIG. 6, a block representation of a CPE 12 is provided according to one embodiment of the present invention. The CPE 12 may include a control system 46 with sufficient memory 48 for the requisite software 50 and data 52 to operate as described above. The control system 46 may be associated with at least one communication interface 54 to facilitate communications over the access network 18 directly or via the residential gateway 22. The control system 46 may also include a user or remote control interface 56 to receive subscriber input directly or through the remote control 26. The CPE 12 may also include the monitor 24 or a monitor output 58, which is capable of providing audio and video to the monitor 24 as well as a separate receiver (not shown) or other component in traditional fashion.

With reference to FIG. 7, a block representation of a server 60 is provided according to one embodiment of the present invention. The server 60 may represent a high bandwidth video server 10, low bandwidth video server 30, guide content server 28, or provide the functionality of any combination thereof. The server 60 may include a control system 62 with sufficient memory 64 for the requisite software 66 and data 68 to operate as described above. The control system 62 may be associated with at least one communication interface 70 to facilitate communications over the delivery network 16 with the CPE 12, residential gateway 22, access gateway 20, and the like.

Those skilled in the art will recognize improvements and modifications to the preferred embodiments of the present invention. All such improvements and modifications are considered within the scope of the concepts disclosed herein and the claims that follow.

What is claimed is:

1. Customer premise equipment comprising:
a communication interface adapted to receive video streams via an access network;
a monitor or monitor output interface to facilitate display of information to a user;
a user input interface adapted to receive input from the user; and
a control system associated with the communication interface, the monitor or monitor output interface, and the user input interface and adapted to:
receive a first low bandwidth video stream comprising first video content for a first channel via the communication interface;
generate a surfing guide comprising a plurality of channel windows, wherein each of the plurality of channel windows is associated with a channel region in a plurality of channel regions;
effect display of the surfing guide with the first video content for the first channel from the first low bandwidth video stream provided in a first channel window of the plurality of channel windows for a first channel region of the plurality of channel regions; and
if the user selects the first channel for viewing from the surfing guide, effect display of the first video content for the first channel from a first high bandwidth video stream.

2. The customer premise equipment of claim 1 wherein the control system is further adapted to request the first high bandwidth video stream in response to the user selecting the first channel for viewing from the surfing guide and receiving the first high bandwidth video stream via the communication interface.

3. The customer premise equipment of claim 1 wherein the control system is further adapted to receive a second low bandwidth video stream in addition to the first low bandwidth video stream, the second low bandwidth video stream comprising second video content for a second channel, and the surfing guide is displayed with the second video content from the second low bandwidth video stream provided in a corresponding one of the plurality of channel windows.

4. The customer premise equipment of claim 1 wherein the control system is further adapted to receive a plurality of low bandwidth video streams in addition to the first low bandwidth video stream, each of the plurality of low bandwidth video streams comprising video content for a corresponding channel, and the surfing guide is displayed with the video content from at least two of the plurality of low bandwidth video streams provided in corresponding ones of the plurality of channel windows.

5. The customer premise equipment of claim 1 wherein the control system is further adapted to receive a static image or graphic associated with a second channel in addition to the first low bandwidth video stream, the surfing guide displayed with the static image or graphic for the second channel provided in a corresponding one of the plurality of channel windows while the first video content from the first low bandwidth video stream is provided in the first channel window.

6. The customer premise equipment of claim 1 wherein initial generation and display of the surfing guide is provided in response to receiving a surfing input from the user, and the first low bandwidth video stream is being received prior to receiving the surfing input.

7. The customer premise equipment of claim 1 wherein the control system is further adapted to determine to generate the surfing guide in response to receiving a surfing input from the user and request the first low bandwidth video stream after receiving the surfing input from the user, wherein the first low bandwidth video stream is not provided until being requested by the control system.

8. The customer premise equipment of claim 1 wherein the control system is further adapted to:
receive a surfing input after effecting display of a first instance of the surfing guide wherein the plurality of channel regions in the surfing guide for the first instance are allocated to a first group of channels;
update the surfing guide for a second instance based on the surfing input;
effect display of the second instance of the surfing guide wherein the plurality of channel regions in the surfing guide for the second instance are allocated to a second group of channels, which is different from the first group of channels.

9. The customer premise equipment of claim 8 wherein the first group of channels and the second group of channels include at least one common channel.

10. The customer premise equipment of claim 9 wherein a difference in channels between the first group of channels and the second group of channels represents scrolling through at least a portion of a list of channels to be surfed.

11. The customer premise equipment of claim 10 wherein the list of channels to be surfed is a numerical list of available channels.

12. The customer premise equipment of claim 10 wherein the list of channels to be surfed is a list of favorite channels.

13. The customer premise equipment of claim 1 wherein the control system is further adapted to, prior to effecting display of the surfing guide:
receive a second high bandwidth video stream comprising second video content for a second channel via the communication interface; and
effect display of the second video content for the second channel from the second high bandwidth video stream; and
receive a surfing input from the user wherein generation and effecting display of the surfing guide is provided in response to the surfing input.

14. The customer premise equipment of claim 13 wherein the surfing guide is displayed with the second video content for the second channel from the second high bandwidth video stream provided in a second channel window of the plurality of channel windows for a second channel region of the plurality of channel regions

15. The customer premise equipment of claim 13 wherein the control system is further adapted to receive a second low bandwidth video stream comprising the second video content for the second channel via the communication interface, wherein the surfing guide is displayed with the second video content for the second channel from the second low bandwidth video stream provided in a second channel window of the plurality of channel windows for a second channel region of the plurality of channel regions.

16. The customer premise equipment of claim 1 wherein the control system is further adapted to:
receive a surfing input from the user when the first channel is deemed active; and
update the surfing guide to indicate that a channel other than the first channel is active in response to the surfing input.

17. The customer premise equipment of claim 1 wherein a plurality of low bandwidth streams for at least a majority of available channels are received all of the time.

18. The customer premise equipment of claim 1 wherein the control system is adapted to update the surfing guide in response to a current surfing action of the user, and low resolution video streams for at least one channel that is deemed likely to be necessary for providing video content in one of the plurality of channel regions in response to a subsequent surfing action is requested and received prior to occurrence of the subsequent surfing action, such that low bandwidth video streams that are likely to be needed in response to the subsequent surfing action are retrieved in advance of being needed.

19. The customer premise equipment of claim 18 wherein the control system is further adapted to predict the at least one channel that is deemed likely to be necessary for providing video content in one of the plurality of channel regions.

20. The customer premise equipment of claim 19 wherein the at least one channel is predicted based on channels currently represented in the surfing guide.

21. The customer premise equipment of claim 19 wherein the at least one channel is predicted based on surfing characteristics of the user.

22. The customer premise equipment of claim 1 wherein each of the plurality of channel regions is associated with a channel, the control system is further adapted to retrieve program information associated with video content for each channel allocated to the plurality of channel regions, and wherein the surfing guide is displayed with program information for each channel being provided in a corresponding one of the plurality of channel regions.

23. A method comprising:
receiving a first low bandwidth video stream comprising first video content for a first channel;
generating a surfing guide comprising a plurality of channel windows, wherein each of the plurality of channel windows is associated with a channel region in a plurality of channel regions;
effecting display of the surfing guide with the first video content for a first channel from the first low bandwidth video stream provided in a first channel window of the plurality of channel windows for a first channel region of the plurality of channel regions; and
if the user selects the first channel for viewing from the surfing guide, effecting display of the first video content for the first channel from a first high bandwidth video stream.

24. The method of claim 23 further comprising requesting the first high bandwidth video stream in response to the user selecting the first channel for viewing from the surfing guide and receiving the first high bandwidth video stream.

25. The method of claim 23 further comprising receiving a second low bandwidth video stream in addition to the first low bandwidth video stream, the second low bandwidth video stream comprising second video content for a second channel, and the surfing guide is displayed with the second video content from the second low bandwidth video stream provided in a corresponding one of the plurality of channel windows.

26. The method of claim 23 further comprising receiving a plurality of low bandwidth video streams in addition to the first low bandwidth video stream, each of the plurality of low bandwidth video streams comprising video content for a corresponding channel, and the surfing guide is displayed with the video content from at least two of the plurality of low bandwidth video streams provided in corresponding ones of the plurality of channel windows.

27. The method of claim 23 further comprising receiving a static image or graphic associated with a second channel in addition to the first low bandwidth video stream, the surfing guide displayed with the static image or graphic for the second channel provided in a corresponding one of the plurality of channel windows while the first video content from the first low bandwidth video stream is provided in the first channel window.

28. The method of claim 23 wherein each of the plurality of channel regions is associated with a channel, and further comprising retrieving program information associated with video content for each channel allocated to the plurality of channel regions, and wherein the surfing guide is displayed with the program information for each channel being provided in a corresponding one of the plurality of channel regions.
